(19) United States
(12) Patent Application Publication
(10) Pub. No.: US 2020/0019539 A1
(43) Pub. Date: Jan. 16, 2020

(54) Efficient and light-weight indexing for massive blob/objects

(71) Applicant: Lei Ni, Beijing (CN)

(72) Inventor: Lei Ni, Beijing (CN)

(73) Assignee: ULimitByte, Inc., Houston, TX (US)

(21) Appl. No.: 16/580,312

(22) Filed: Sep. 24, 2019

(51) Int. Cl. G06F 16/22; G06F 16/215; G06F 16/23

(52) U.S. Cl. CPC G06F 16/2219; G06F 16/2264; G06F 16/2379; G06F 16/2255; G06F 16/215; G06F 16/2246

(57) ABSTRACT

The subject disclosure is directed to an indexing technology for massive blob/objects, in which a Multi-Level Index and a well-designed hash function work together to reduce the low-latency memory consumption and to finish the Blob lookup/insertion/deletion operations with fixed and limited IO Requests (including read/write). Every blob is uniquely identified by its fingerprint. All the fingerprints are stored in the Multi-Level Index which includes Root Index, Intermediate Indexes and Leaf Index. There may be 0 or 1 or more intermediate indexes. All of these indexes in the Multi-Level Index are built on non-volatile storage. The Insertion Buffer, Deletion Buffer are built in the primary storage or secondary storage, and they are used to resolve the write amplification for the indexes in the Multi-Level Index.

### FIELD OF THE INVENTION

The present invention relates to Database Management System, File System or data Storage Systems.

### BACKGROUND OF THE INVENTION

Generally, massive blobs are managed by Database Management System (DBMS). DBMS provides SQL language and Programming Interfaces to manipulate the blobs which includes inserting one or more blobs to the Database, querying a set of blobs from the Database, updating one or more blob from the Database and deleting a bundle of blobs from the Database.

However, if the total number of blobs reaches up to 1 billion, the classical algorithm such like B-Tree doesn't work smoothly any more. In some use cases, the number of blobs may reach to 8 billion or 64 billion and even more.

Assuming the index is built on disks, every Insertion/Deletion/Update operation requires updating for the metadata of the index. If the metadata resides on fixed storage address, this place is being accessed and updated so frequently to become the hot spot. With the growth of the index, the hot spot may lead to storage medium failure or does harm to the endurance and lifecycle of the storage medium.

The commonly used solution for maintaining index for massive Blobs is to allocate a large amount of low latency memory for caching part of the index to accelerate the searching workflow and to reduce the number IO requests issued to the index. There are two problems for this solution: the first one is high low-latency memory usage, and the second one is that it doesn't take effect under all scenarios.

For the first problem, in fact some systems cannot afford so much low-latency memory for building the index, but they have the requirement for the indexing service, such like embedded systems, mobile devices, desktop, servers, etc.

For the second problem, part of the index is loaded into low-latency memory with predefined patterns. For example, if the massive Blobs are being accessed by predefined and limited user behaviors, then the Locality Principal works well under this scenario, and the neighborhood Blobs together with their metadata can be loaded ahead to the low-latency memory. These blobs with their metadata have the highest possibility to be accessed in the recent future. But if the Blobs are being accessed in random manner, then the locality principal doesn't take effect.

What's needed is a common solution for efficiently organizing the index for massive blobs and deliver the blob manipulation which includes insert/query/delete by limited and fixed IO requests (includes read/write) with low computing and primary storage resource consumptions.

### BRIEF DESCRIPTION OF THE DRAWING

Embodiments of inventive concepts will be more clearly understood from the following detailed description taken in conjunction with the accompanying drawings in which:

FIG. 1 is a block diagram illustrating an indexing service for massive blob/objects embodiment according to the present invention.

FIG. 2 illustrates the data layout of the Leaf Index embodiment according to the present invention.

FIG. 3 illustrates the data layout of the Intermediate Index embodiment, according to embodiment of the present invention.

FIG. 4 illustrates the data layout of the Root Index embodiment, according to embodiment of the present invention.

FIG. 5A is a flow chart illustrating Blob Insertion & Query Operation with the Indexing Service, according to embodiment of the present invention.

FIG. 5B illustrates the lookup operation based on the Blob's fingerprint and the hash value for the fingerprint, and the lookup operation starts from the Root Index, ends to the Leaf Index.

FIG. 6 is a flow chart illustrating the first part of the merge process from the Insertion Buffer to the Multi-Level Index, according to embodiment of the present invention.

FIG. 7 illustrates the requirement for Fingerprint Generator and Hash Function, according to embodiment of the present invention.

FIG. 8 illustrates the data layout in the primary memory for Blob Group, according to embodiment of the present invention.

FIG. 9 illustrates the data layout in the primary memory for IO Group, according to embodiment of the present invention.

FIG. 10A is a flow chart illustrating how to merge a single IO Group to the Multi-Level Index, according to embodiment of the present invention.

FIG. 10B illustrates the updating process for the Intermediate Index and the Root Index, according to embodiment of the present invention.

FIG. 11 illustrates what considerations should be taken while determining the exact size for the Insertion Buffer, according to embodiment of the present invention.

### DETAILED DESCRIPTION

Hereinafter, embodiments of inventive concepts will be described in detail with reference to the accompanying drawings.

Every Blob represents variable length of data, it is also often called as “Object”, “Data Chunk”, “Data Segment” or “Data Fragment”.

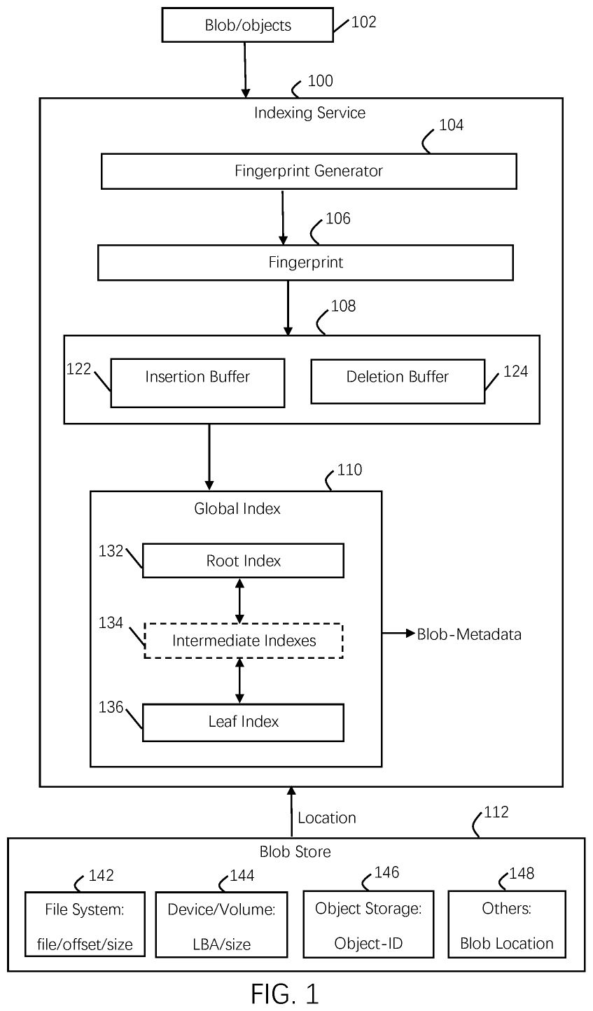

Since blobs are in variable length, to make things easier, fingerprint is calculated for referencing one blob. The fingerprint is a unique long number which uniquely identifies one blob and will not cause any collisions among all fingerprints in the Global Index (FIG. 1, 110). Hence one Blob is uniquely associated with one fingerprint, and one fingerprint can uniquely identify one specific Blob.

With the concept of “fingerprint”, all the operations on a Blob in the Indexing Service (FIG. 1, 100) can be converted to operations on its fingerprint:

To query if one specified Blob exist, it's equivalent to query if its fingerprint exists in the Global Index;
To insert one Blob, it's equivalent to store the Blob itself to the storage system and insert its fingerprint to the Global Index;
To delete one Blob, it's equivalent to delete the Blob from the storage system and delete its fingerprint from the Global Index.

FIG. 1 is a block diagram illustrating an indexing service for massive blob/objects embodiment according to the present invention.

The Indexing Service 100 includes Fingerprint Generator 104, Fingerprint 106, Insertion Buffer 122, Deletion Buffer 124 and Global Index 110.

Blob/objects 102 is the input for the Indexing Service 110. One or more Blob/objects may come from variable data sources, such like File System, Database Management System, Device, Object Storage, or other types of Storage.

Blob Store 112 is the other input for the Indexing Service 100. The massive blobs are finally stored to the Blob Store. The Blob Store may be built on File System, Network Shared Folder (such like NFS or CIFS/Samba or FTP), Hard Drive, Solid State Drive, Volume, Object Storage, Cloud Storage, etc. 142-148 are examples for the underlying storage types and storage location formats for Blob Store. For File System, the storage location for a Blob may be filename, offset in the file, size of the blob. For Device and Volume, the storage location for a Blob may be Logical Block Address (LBA) and size of the blob. For object storage, the storage location for a Blob is the Blob's Object-ID. Anyway, no matter what types of storage is used to store the Blobs, the Indexing Service needs the Blob Store to provide every Blob's storage location. Storage Location is an attribute of the Blob and this attribute is treated as part of the Blob's metadata. This attribute will be saved to the Global Index 110.

The Fingerprint Generator 104 is used to generate the Fingerprint 106 for the Blob which can identify the Blob uniquely in the Global Index 110. The Fingerprint Generator must make sure that every Fingerprint it generates is 100% uniquely in the whole Global Index and definitely will not cause any collisions no matter how many Blobs the Global Index keeps.

There is a predefined algorithm to compare two fingerprints. The result is “smaller” or “greater”. The only requirement for the comparation algorithm is that it must picks up all the fingerprints uniquely and definitely cannot run out the “two fingerprints are equal” result. The simplest comparation algorithm is treating every Fingerprint as a large integer number, and sort the large integer numbers according to their value.

Insertion Buffer 122 and Deletion Buffer 124 are used to resolve the write amplification for Global Index 110.

The Global Index 110 includes the Multi-Level Index: Root Index 132, Intermediate Indexes 134 and Leaf Index 136. Root Index is the internal index for Intermediate Indexes. There may be zero or 1 or more Intermediate Indexes according to the scale of the number of Blobs. And Intermediate Indexes is also an internal index for the Leaf Index.

The Leaf Index 136 stores all the Blob metadata information, whereas the Root Index 132 and Intermediate Indexes 134 don't contain any Blob metadata information because they are only used to fasten the searching operation for the Leaf Index. All the indexes are stored in the non-volatile storage. The Leaf Index is the biggest index and definitely cannot be fully loaded into the primary storage. The Intermediate Indexes generally are also bigger enough for the low-latency memory resource. The Root Index is smaller and is loaded to the low-latency memory.

Assuming there are 64 billion Blobs, and the metadata size for every Blob is 64 bytes, then the size of Leaf Index 136 is 4 TB length. It can be organized in a single file, multiple files, a dedicated file system partition, a raw disk/volume, etc. Since it contains huge data, partition must be made on the Leaf Index to make the management efficient. It can be partitioned into multiple groups, and every group can be furtherly partitioned into smaller groups as well.

In the following description of the invention, the Leaf Index 136 is assumed to be organized in continuous pages. Although it can be organized in other structures, the invention selects the easiest structure to simplify our illustration.

Every page has the fixed size which is determined by the underlying Operating System and the underlying storage characteristics. For example, for most popular Operating Systems, the page size is 4 KB or 64 KB. It's always a good practice to select the same page size with the underlying Operating System because this will make full use of the benefits of the Operating System such like the buffer cache, read ahead cache, etc. And the underlying storage characteristics also plays an important role in determining the page size. For example, if the secondary storage is magnetic hard disk, then the page size must be multiple of the hard drive's sector size so that the Multi-Level Index can leverage the write-cache, read-cache, native command queue (NCQ) features and other advanced features provided by the magnetic hard disk. These advanced features provided by the magnetic hard disk will greatly reduce the number of IO requests, and improve the disk performance in the maximum extend to reaches nearly to the theorical upper limit of the magnetic hard drive.

If the underlying secondary storage is SSD, the page size should be the multiple of the processing unit of the SSD drive. Generally, the processing unit is set to 4 KB.

If the underlying secondary storage is Object Storage, then Multi-Level Index's page size must be aligned with the specification of it.

The Leaf Index 136 contains all the Blobs' metadata information. It is composed by continuous pages. Every page consists of the page's statistics information, page number, checksum and a set of records. Every record represents a Blob's metadata information which includes fingerprint, location in the Blob Store 112, size of Blob and other attributes for the Blob. All the records in the same page have the same hash value. So, the Leaf Index is organized and partitioned by hash value. For example, two new Blobs blob1 and blob2 are received one after the other, but Leaf Index doesn't store them in the neighborhood, instead it stores blob1's metadata in page Pᵢ whereas blob2's metadata in another page Pⱼ because the hash value for blob1's fingerprint is H1 and the hash value for blob2's fingerprint is H2. According to the Intermediate Index 134, fingerprint with hash value H1 should be put to page Pi, and fingerprint with hash value H2 should be put into page Pj.

The Intermediate Indexes 134 may be 0, 1, or more. The number/level of Intermediate Indexes is determined by the designed upper limit number of Blobs managed by the Indexing Service 110. If the designed upper limit Blob number Service is only 1 million, the Intermediate Indexes are not needed at all. If the designed upper limit Blob number is 64 billion, then the size of Leaf Index 136 is in 4 TB length, then there must be at least 1 Intermediate Index. With the increasing Blob number, the level of Intermediate Indexes increases as well.

The Root Index 132 keeps the mapping from hash value to the page number in Intermediate Index 134 or Leaf Index 136. If there are no Intermediate Indexes at all, the Root Index maps the hash value to page number in the Leaf Index directly. And if there are Intermediate Indexes, the Root Index maps the hash value to page number in the Top-Level Intermediate Index. If there are multiple Intermediate Indexes, the Top-Level Intermediate Index maintains the summary information for the next-level Intermediate Index and the Low-Level Intermediate Index maintain the summary information for the Leaf Index. In the following of the invention, to make the illustration easier, only one Intermediate Index is chosen to simplify the illustration of the embodiment.

The Intermediate Index 134 consists of a set of records. Every record describes the summary information of a single page in the Leaf Index 136. The metadata information contains the page number, hash value, maximum fingerprint and minimum fingerprint in the page. Similar to the Leaf Index, the Intermediate Index can be organized in different types, such like a single file, multiple files, a dedicated file system partition, raw disk/drive, etc. Also similar to the Leaf Index, the Intermediate Index can be partitioned into groups according to hash value. Here, to make the invention's illustration simpler, the easiest data layout is selected: Intermediate Index is organized by continuous pages. And the records are distributed in the pages according to the hash value.

The Root Index 132 is a mapping table from hash value to page numbers in the Intermediate Index 134. Given one hash value, the Root Index tells the corresponding page numbers in the Intermediate Index. In this invention, the “hash value” refers to the hash value of a given Fingerprint.

Insertion Buffer 122 is used to temporarily keeps the new Blobs' metadata information. The Insertion Buffer is organized in a set of records, every record stand for one Blob's metadata information.

The purpose for Insertion Buffer 122 is to resolve the write amplification for Leaf Index 136. Since this invention is for Storage System, Database Management System or File System, every new Blob's metadata information must be flushed to the non-volatile storage before the Blob Operation (Insertion/Deletion/Update) finishes. If the Blob's metadata is kept in the primary storage, Operating System's buffer, or Write-Cache of the Hard Drive, or anywhere not the non-volatile storage space, data loss may happen upon hardware failure, power loss or software failure. To avoid the potential data loss, the new Blob's metadata information must be written permanently to the final storage space before returning the result to the caller. But this will cause huge write amplification without the Insertion Buffer, because every Blob's metadata only occupies a few bytes, but flushing these few bytes to the non-volatile storage actually writes far more bytes than the bytes that a single Blob's metadata occupies. If the underlying storage is a magnetic hard drive, the smallest flushing unit is one sector which is 512 bytes or 4 K bytes. Just assuming that the Blob's metadata is 64 bytes long, then the write amplification is 8 times or 64 times. More severe problem is the Leaf Index's metadata which gets updated whenever any page of the Leaf Index gets updated. This does harmful for the endurance and lifecycle of the underlying non-volatile storage's medium.

Furtherly, since Leaf Index 136 is partitioned by hash value, the received Blobs' metadata information may be distributed randomly into different pages. For example, 1024 new Blobs blob1, blob2, . . . , blob1024 are received by the Indexing Service 110 one by one, they have Fingerprint1, Fingerprint2, . . . , Fingerprint1024 respectively, and hash values for their Fingerprints are H1, H2, . . . , H1024 respectively. These Blobs' metadata information is determined to be written to page P1 for blob1, and page P2 for blob2, . . . , page P1024 for blob1024. The Fingerprints are totally random and the hash values are totally random too, so the 1024 page-numbers may be totally different. Assuming the Leaf Index is built on one magnetic hard drive, and the drive sector size is 4 KB and assuming the page size is 4 KB, assuming every Blob's metadata information occupies 64 Bytes, then the hard drive has to write 1024 sectors for the 1024 Blobs' metadata information. The total writing size from the disk layer is 1024*4 KB=4 MB, and the actually written data is only 64B*1024=64 KB. In other words, the actually data expected to be written is only 64 KB, but the hard drive has to write 4 MB to finish the writing.

Insertion Buffer 122 resolves write amplification by buffering the Write IOs, and dispatches them until the number of records for every page in the Leaf Index 136 has reached to the threshold.

Since Insertion Buffer 122 is used by the Leaf Index 136, it contains all the required metadata information for the Leaf Index. Only when the number of records reaches to the threshold, all the records in the Insertion Buffer will be merged to the Leaf Index.

Insertion Buffer 122 may be implemented in the low-latency memory or in the secondary storage, in depends on the size of the Insertion Buffer and the low-latency memory assigned to the Indexing Service 100. The size of the Insertion Buffer is determined by the hash function and the threshold, wherein the hash function determines how many buckets and the threshold determines the number of records for every bucket. For example, the hash function has 65536 buckets and the threshold for every bucket/hash-value is 64 records, furtherly assuming the record size is 64 bytes, then the size of the Insertion Buffer is 65536*64*64 Bytes=256 MB. Here, the threshold 64 is for every bucket/hash-value, in the event that there are multiple pages for every bucket, the 64 records are distributed into the multiple pages. With the growth of the Leaf Index 136, the Insertion Buffer size may grow adaptively to reduce the write amplification.

Insertion Buffer 122 is partitioned by hash value. It can be implemented in Red-Black Tree, binary tree, B-Tree, etc. to accelerate the searching operation for some a fingerprint in the Insertion Buffer.

The Deletion Buffer 124 acts as the similar role as the Insertion Buffer 122 which is to reduce the write amplification for the Blob deletion operation. Deletion Buffer is used to temporarily keeps the user-initiated Blob deletion operations. The Deletion Buffer is organized in a set of records, every record stand for one Blob's deletion operation. Only when the number of records reaches to the threshold, all the deletion operations in the Deletion Buffer will be performed batch on the Leaf Index 136. Note that deletion on Leaf Index means the upper level indexes which includes the Intermediate Index 134 and the Root Index 132 must get updated accordingly.

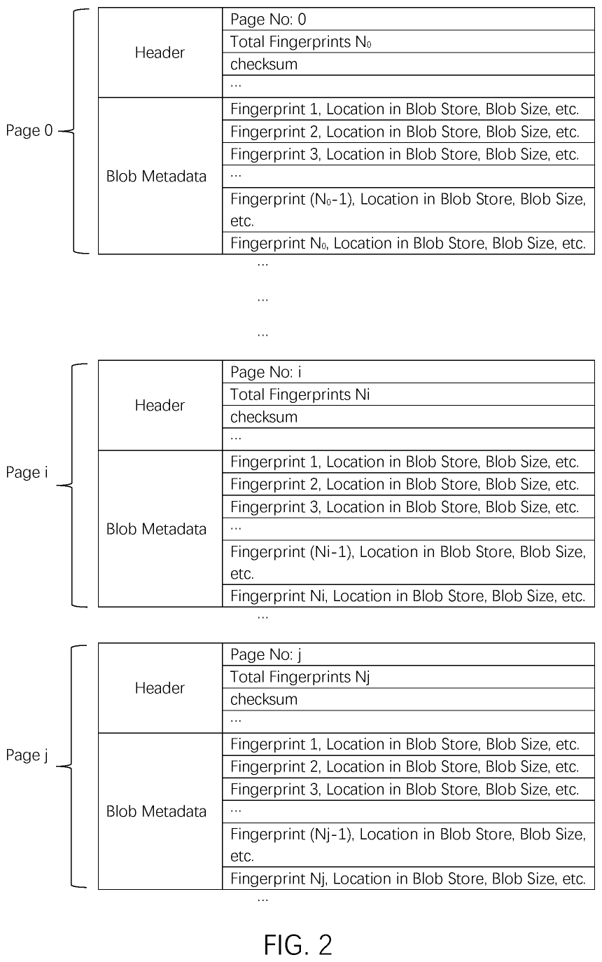

FIG. 2 illustrates the data layout of Leaf Index 136. The Leaf Index is composed by continuous pages. Every page consists of the page's statistics information, page number, checksum and a set of records. Every record represents a Blob's metadata information which includes fingerprint, location in the Blob Store 112, Blob size and related attributes. All the records in the same page have the same hash value.

Inside of one page, all the records are sorted by their fingerprint values. All the pages follow the same sorting algorithm and the same sorting order.

The Leaf Index 136 commonly uses multiple pages to stores the records with the same hash value. No matter how many pages are used for the hash value, the records in all the pages are sorted by their fingerprint values which means the first page's first record has the least fingerprint, and the second page's first record has a larger fingerprint than the first page's last record's fingerprint, and finally the last page's last record has the largest fingerprint. Note that here the first page may not refer to the page with the least page number, and the last page may not refer to the page with the largest page number.

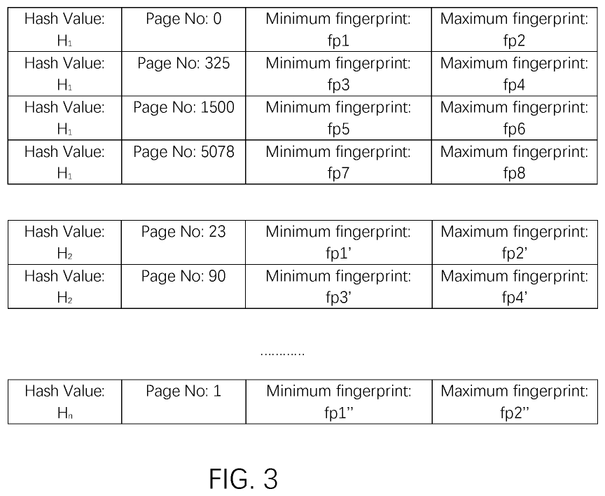

FIG. 3 illustrates the data layout of the Intermediate Index 134 in the event that there is only one Intermediate Index. It consists of a set of records. Every record describes the summary information of a single page in the Leaf Index 136. The metadata information contains the page number in the Leaf Index, the hash value, maximum fingerprint and minimum fingerprint in the page.

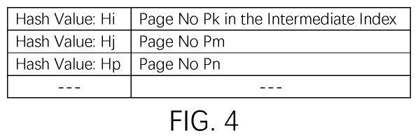

FIG. 4 illustrates the data layout for the Root Index 132. It is a mapping table from the hash value to the page number in the Intermediate Index 134 in the event that there is only one Intermediate Index. If there are multiple Intermediate Indexes, the Root Index maps the hash value to a page number in the top-level Intermediate Index.

Assuming there is only one Intermediate Index 134, given a hash value, Root Index 132 tells the page numbers in the Intermediate Index, and in these pages, the Intermediate Index maintains the summary information for the pages in the Leaf Index 136 corresponding to the hash value. For every given hash value, there may be zero, one or more mapping relationships in the Root Index.

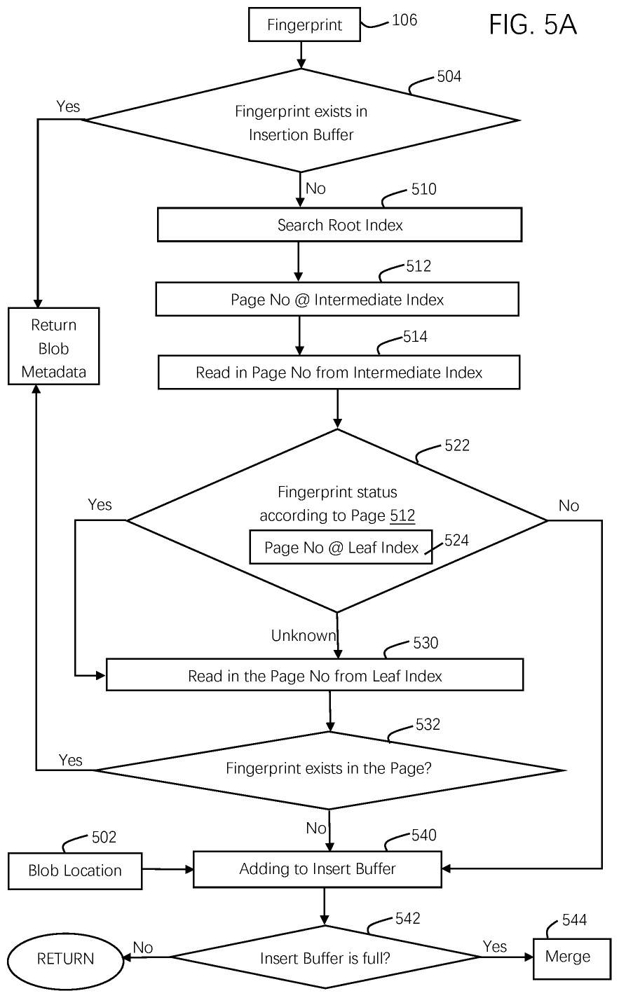

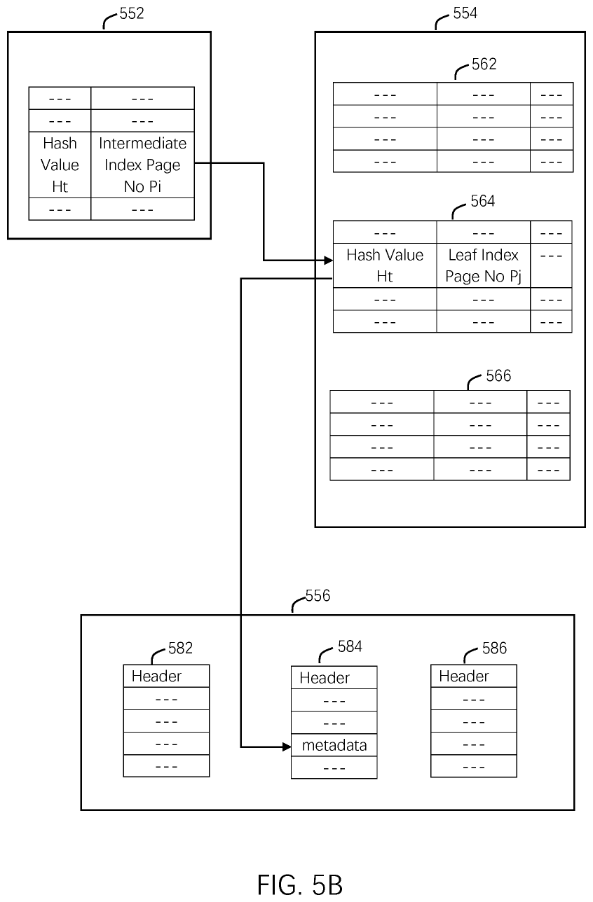

FIG. 5A is a block diagram for the Insertion & Query operation for a single Blob/Fingerprint. The insertion process involves the whole process of Query, so these two workflows are illustrated in a single diagram. When one Fingerprint (FIG. 1, 106) is received, firstly searches from the Insertion Buffer (FIG. 1, 122) to see if some record matches the Fingerprint (504). The Insertion Buffer is comprised of a set of records and every record represent a single Blob's full metadata information. If there is a record with the exact Fingerprint, it means the Fingerprint already exists in the Insertion Buffer and will be merged to the Leaf Index (FIG. 1, 136) in future. Otherwise if no records match the Fingerprint, it means this Fingerprint doesn't exist in the Insertion Buffer. The record in the Insertion Buffer contains all the metadata information for a single Blob, if the Blob with the Fingerprint is determined not a new one, retrieves the Blob's full metadata information and returns to the caller.

If this is a Blob Query operation, the caller now gets the Blob's full metadata includes its location in the Blob Store (FIG. 1, 112). The caller will definitely locate the Blob in the Blob Store and do the future processing for the Blob.

If this is Blob Insertion operation, the operation finishes.

If the Insertion Buffer (FIG. 1, 122) is organized in the low-latency memory, this step can be done in the memory. Otherwise if it's organized in the secondary storage, one READ IO Request is issued to the storage. So, this step requires at most 1 Read IO.

If the Fingerprint doesn't exist in the Insertion Buffer, searching (510) the Root Index (FIG. 1, 132) to get the corresponding page number 512 in the Intermediate Index (FIG. 1, 134). To do the searching in the Root Index, the first thing is to calculate the Fingerprint's hash value. When the required hash value is calculated, make the search in the whole Root Index.

As mentioned in the invention, there may be zero or one or more Intermediate Indexes (FIG. 1, 134), but to make the illustration simpler, there is only one Intermediate Index in FIG. 5. If the Intermediate Index is fully loaded to the primary storage, there is no IO operation involved, otherwise one READ IO is issued to the Intermediate Index to read the page 512 to the low-latency memory (514).

The Intermediate Index (FIG. 1, 134) keeps all the pages' metadata information from the Leaf Index (FIG. 1, 136). The intermediate Index is composed by a set of records, every record maintains the summary information for a single page in the Leaf Index. Specifically, it contains every page's page number, hash value, maximum fingerprint and minimum fingerprint of the page. After searching all the records in the page number 512, the Fingerprint may be determined to exists, not exists or unknown (522) in the Global Index (FIG. 1, 110). There are such possible search results list below (522):

(a), the hash value does NOT exist in the page of the Intermediate Index;

In this scenario, the Fingerprint doesn't exist in the Global Index and it must be a new Fingerprint. The new Fingerprint will be added to the Insertion Buffer (540), and its storage location 502 must be determined by the Blob Store (FIG. 1, 112) as well. The Leaf Index (FIG. 1, 136) will allocate a new page to hold the corresponding new Blob's metadata information. The new allocated page is the Leaf Index page number 524.

(b), the hash value exists in the page and the Fingerprint duplicates with one record's maximum fingerprint or minimum fingerprint;

In this scenario, the Fingerprint is a duplicate fingerprint. However, at this stage, the Blob's storage location in Blob Store is unknown. The Leaf Index page number 524 is the “page number” field from the record. The Leaf Index Page 524 must be read in because it contains the full Blob's metadata information.

(c), the hash value exists in the page and the Fingerprint is bigger than one record's minimum fingerprint but smaller than the same record's maximum fingerprint;

In this scenario, the Fingerprint may exist or not exist. The result is “Unknown”. And the Leaf Index page number 524 is the “page number” field of the current record. This Leaf Index Page 524 must be read in as well to get the corresponding Blob's full metadata information.

(d), the hash value exists in the page but the Fingerprint is smaller than the first record's minimum fingerprint;

In this scenario, the Fingerprint is a new fingerprint. And it will be inserted to the Insertion Buffer (540), and the Blob's storage location 502 is determined by the Blob Store as well. And the Leaf Index page number 524 where the new Fingerprint will be inserted to is the “page number” field in the first record.

(e), the hash value exists in the page but the Fingerprint is larger than the last record's maximum fingerprint;

In this scenario, the Fingerprint is a new fingerprint. And it will be inserted to the Insertion Buffer (540), and the Blob's storage location 502 is determined by the Blob Store (FIG. 1, 112) as well. And the Multi-Level Index page number 524 where the new Fingerprint will be inserted to is the “page number” field in the last record.

(f), the hash value exists in the page and the Fingerprint is larger than the former record's maximum fingerprint but smaller than the next record's minimum fingerprint.

In this scenario, the Fingerprint is a new fingerprint. And it will be inserted to the Insertion Buffer (540), and the Blob's storage location 502 is determined by the Blob Store (FIG. 1, 112) as well. And the Leaf Index page number 524 where the new Fingerprint will be inserted to is the “page number” field in the former record.

Conclusively, if the Fingerprint doesn't exist, it will be inserted to the Insertion Buffer with a Leaf Index page number 524 where the new Fingerprint will be inserted to. Otherwise if the Fingerprint exists or cannot tell if the Fingerprint exists, the Leaf Index page must be read in to the low-latency memory (530) because the Intermediate Index (FIG. 1, 134) doesn't contain the storage location information hence cannot return to the caller. Even if the Fingerprint is determined to already exist in the Global Index (FIG. 1, 110), the Intermediate Index cannot tell where the corresponding Blob is stored, that's why the Leaf Index page must be read in.

The Page 524 in Leaf Index (FIG. 1, 136) is composed by a set of records, every record stand for a Blob's metadata information. Looping over all the records in the page to find if the Fingerprint matches any record (532). If some a record has the same fingerprint value with the received Fingerprint, then the received Fingerprint must be a duplicate one; otherwise it must be a new one. If the received Fingerprint is determined to be duplicate, retrieves all the corresponding Blob's metadata information from the record and returns to the caller. If the received Fingerprint is determined to be a new one, it will be inserted to the Insertion Buffer (540).

The Root Index (FIG. 1, 132) must be loaded to the low-latency memory. The Intermediate Index (FIG. 1, 134) may be fully loaded into memory or not. And the Leaf Index is not fully loaded to the memory. So, this searching process involves one or two READ IO Requests.

So far, together with the READ IO Request issued to the Insertion Buffer, at least one at most 3 READ IO Requests are dispatched to the secondary storage. In this invention, secondary storage means any underlying storage where the Leaf Index is finally stored, such like magnetic hard drive, solid state drive, network file system, cloud storage, etc. And the low-latency memory refers to RAM memory, NVME, Flash Memory or any other memory which have lower latency than the secondary storage.

After inserting a new fingerprint to the Insertion Buffer, if it becomes full (542), the whole Insertion Buffer must be merged to the Global Index (544); otherwise return directly to the caller.

Above all, at the worst situation, there are 3 READ IO Requests, and every IO Request is of page size (normally 4 KB or 64 KB) to tell if the arrival fingerprint exists or not. Under the best situation, only one READ IO Request is involved.

FIG. 5B furtherly illustrates the searching process in the Multi-Level Index in the event that the process starts from the Root Index and ends in the Leaf Index. 552 is the Root Index data layout, 554 is the Intermediate Index data layout, and 556 is the Leaf Index data layout. 562-566 represents a single page in the Intermediate Index, as an example there are only 3 pages, in the reality there are much more pages in the Intermediate Index. Specifically, 564 stands for the page with page number Pi. 582-586 represents a single page in the Leaf Index, as an example there are only 3 pages, in the reality there are much more pages in the Leaf Index. Specifically, 584 stands for the page with page number Pj.

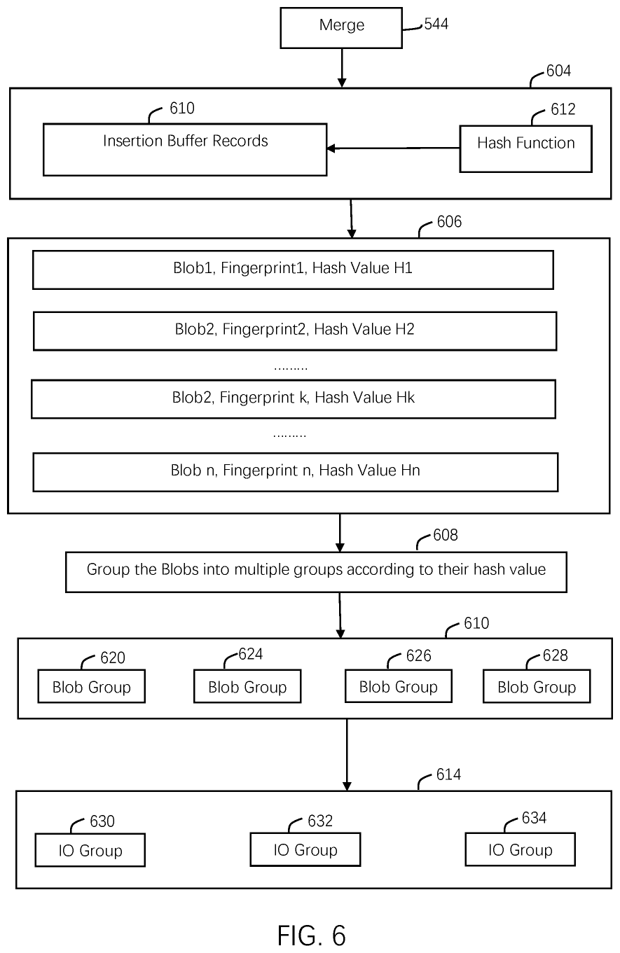

FIG. 6 is a block diagram for the first part of Merging process (FIG. 5A, 544). When the Insertion Buffer (FIG. 1, 122) reaches to the threshold, it's time to batch merge all the metadata records in the Insertion Buffer to the Leaf Index (FIG. 1, 136) which includes updating for Intermediate Index (FIG. 1, 134) and Root Index (FIG. 1, 132) as well.

At the first step (604), loop over for all the records in the Insertion Buffer (610), and for every record calculates the Fingerprint's hash value according to the Hash Function 612.

After this step, every Blob is attached with a unique Fingerprint and hash value (606). These Blobs are grouped into Blob Groups 610 according to the hash value (608). In other words, one bucket of the hash function is 1:1 mapped to a single Blob Group 620-628. There are only 4 Blob Groups in FIG. 6 for an example, in the reality the Blob Group number is the same as the bucket number in the Hash Function.

Furthermore, Blob Groups 610 are grouped again into the IO Groups 614. Every IO Group 630-634 contains one or more Blob Group 620-628. As an example, there are only 3 IO Groups in the FIG. 6, in the reality, there are much more IO Groups.

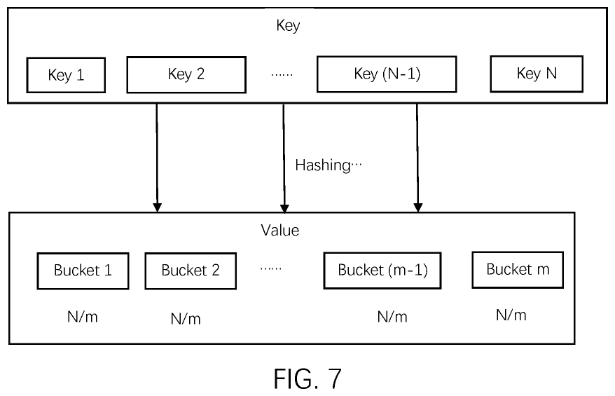

FIG. 7 illustrates the most important requirement for Fingerprint Generator & Hash Function: keys are equally distributed on the buckets.

The fingerprint Generator (FIG. 1, 104) is responsible to make every fingerprint uniquely in the whole Global Index. The requirement for the Hash Function (FIG. 6, 612) is to map the keys equally to the buckets, which means every bucket owns the same number of keys. The Fingerprint Generator algorithm may be various hash algorithms, such as HAVAL, MD2, MD4, MD5, SHA-1, SHA-256/224, SHA-512/384, and/or WHIRLPOOL, together with an XOR of the Blob context. These various hash algorithms make sure the output value is random, in other words it has least possibility for collisions. However, there is still a very low possibility for collisions. By adding the XOR of the Blob context to the hash value will reduce the collisions to nearly impossible. And the Hash Function may be a series of bit operations on the Fingerprint. The number of buckets for Hash Function is much lesser than the Fingerprint Generator's hash algorithms. Here the bit operations include data left/right shifting by several bits, data rolling by several bits, N-bits' checksum/CRC on the Blob context or on the Fingerprint and XOR on a few fragments of data. Anyway, the key idea for designing the hash functions is that the mapping must be equally distributed among all their buckets.

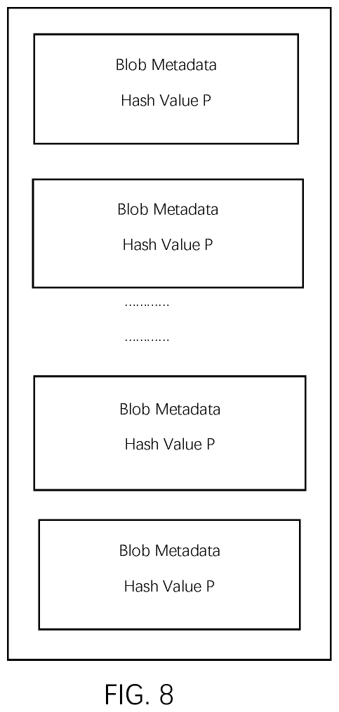

FIG. 8 illustrates the data layout for one Blob Group (FIG. 6, 620-628). Every Blob Group contains a set of records. Every record represents one Blob's metadata information which includes Fingerprint, Hash Value and other attributes. The records in the group have the same hash value.

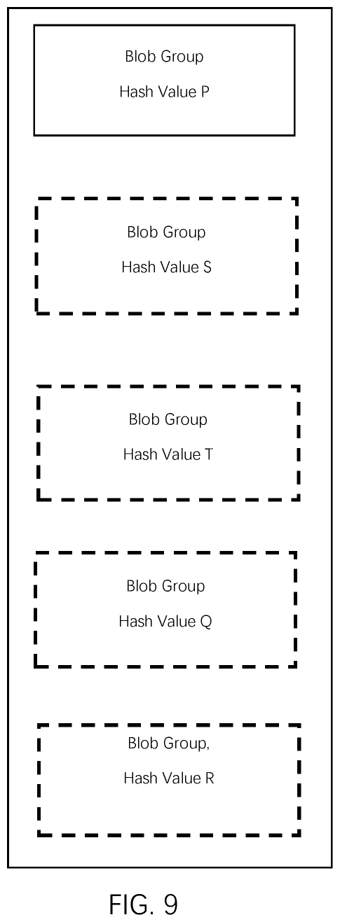

FIG. 9 illustrates the data layout for one IO Group (FIG. 6, 630-634). One IO Group consists of one or more Blob Groups (FIG. 6, 620-628). Every record in the Blob Group contains the Leaf Index Page No (FIG. 5A, 524). The IO Group generates a READ IO Request for the page, then adding the corresponding new Blob's metadata information to the page, finally writing the page back to the Leaf Index. In this process, the page may be split to two pages. Moreover, the Intermediate Index and Root Index needs to get updated too.

The size of IO Group is determined by the underlying Operating System, computing and primary storage resources assigned to the Indexing Service (FIG. 1, 100), the underlying storage medium on which the Global Index is built and the Network-Bandwidth/IO-Bandwidth between the Indexing Service and the underlying storage. The following examples illustrate how to make a good decision.

If the underlying storage medium is Cloud Storage provided by the public cloud vendors, the storage itself generally supports high IO throughput and high parallel async IO handling capability, so the storage is not the bottleneck. Under this scenario, the IO Group size is determined by the network bandwidth and network packet transmission time between the Indexing Service and the Cloud Storage. For example, if the network bandwidth is 64 MB/s between the Indexing Service and the Cloud Storage, and the average IO processing time (including the time spent on the network round trip-RTT) is 0.1 seconds, and assuming the page size is 4 KB, then the IO Group size can be set to 64 MB/4 KB/10=3,200 pages.

If the underlying storage medium is a network share such like SAMBA/NFS/FTP in the local network environment, then the network bandwidth is not a problem and the IO Group size is determined by the processing performance from the remote side. For example, if the remote NFS server can provide 64 MB/s' processing throughput for the Indexing Service, and assuming the page size is 4 KB, then the IO Group size can be set to contain only 1 Blob Group.

If the underlying storage medium is a single magnetic hard drive with RPM 1000, and the underlying Operating System supports at most 1 MB for every IO request, then the maximum IO Group size can be set to 1000*1 MB/4 KB=256,000 pages. Of course, this is the theorical upper limit and this upper limit can be reached only when every IO request is of 1 MB size and this IO request can be finished in a single mechanical spin/round of the magnetic hard drive.

If the underlying medium is SSD, then the IO Group size is limited by the System Bus bandwidth from the Indexing Service to the SSD Disk, SSD throughput and IOPS, and the primary storage resources to fulfill the IO requests because SSD supports random access. If the System Bus is fast enough and the SSD throughput is 8 GB/s, assuming the page size is 4 KB, and the whole IO processing time (from issuing from the caller to the IO Request returns to the caller) is 1 millisecond, also assuming the RAM resource is unlimited, then the IO Group size can be set to 8 GB/1000/4 KB=2,000 pages. In theory, the maximum IO Group size logically can be set to 8 GB/4 KB=2,000,000 pages. In fact, this is only from theory because it requires 8 GB low-latency memory resources.

As a conclusion, the IO Group size is determined by the computing/low-latency memory/network resources from local side and remote side and the characteristics of the underlying storage medium. Here remote side and local side is separated according to the Global Index. The side on which the IO Request is sent out is the local side, and the side on which the IO request is received is the remote side.

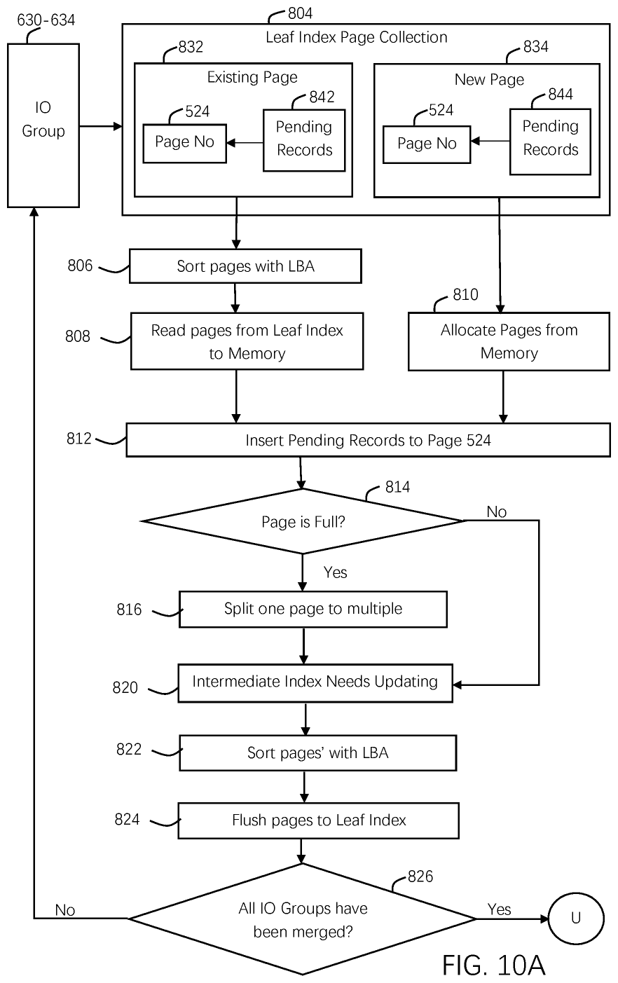

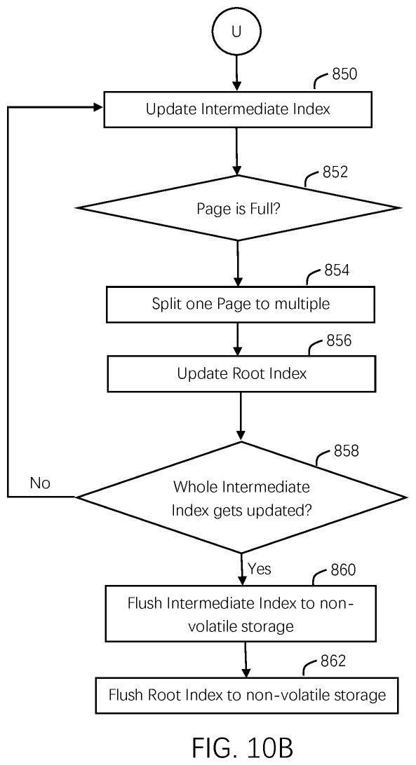

FIG. 10A is the block diagram to illustrates how the IO Group (FIG. 6, 630-634) being merged to the Global Index. One IO Group contains one or more Blob Group, and every Blob is attached with full metadata which includes the indicating page number (FIG. 5A, 524) in the Leaf Index (FIG. 1, 136) where the Blob's metadata information should be inserted to. According to the page number, the IO Group can be organized into a page collection 804. In the page collection, every page is attached to a set of records 842/844, and every record represent one Blob's full metadata information. In the page collection, some pages are the existing pages 832 in the Leaf Index, and some are new pages 834 which are not available in the Leaf Index yet. In FIG. 10A, there is only one “Existing Page” and one “New Page” as example, in the reality, there are many “Existing Page” and/or “New Page”.

For all the Existing Pages 832 in the IO Group, mapping every page into one READ Request. All the READ requests must be sorted according to their Logical Block Address (LBA) address of the underlying storage medium to get the best performance before being dispatched to the underlying storage (806). After reading, the contents of the pages are read into memory (808).

For all the New Pages 834 in the IO Group, allocating them in the low-latency memory (810). And this step involves Intermediate Index update (820). For every new allocated page, the Intermediate Index will append a new record to represent this page's summary information.

When all the Existing Pages 832 and New Pages 834 are all prepared in the low-latency memory, inserting every page's pending records 842/844 to the related page respectively (812). The insertion operation must follow the records' sorting criteria. After insertion, all the records in a single page must be sorted in the same order as before. If the page is full (814), it must be split into multiple pages (816). If one page is split into two pages, then the first page keeps the first half records in the original page, whereas the second page keeps the last half records. After splitting, the two pages still follow the records' sorting criteria. Since the Intermediate Index keeps the summary information for every page in the Leaf Index, after page splitting, the Intermediate Index needs to be updated as well (820). If the page is not full after pending records' insertion, the Intermediate Index may need to be updated as well because the Intermediate Index keeps the maximum and minimum Fingerprint in the page (820). After pending records' insertion, the maximum and minimum Fingerprint in the records of the page may get updated.

Now, the pending records have been merged to the pages in the low-latency memory. Next step is to writing the pages which includes the Existing Page and New Page back to the Leaf Index. Every page here is mapped to one WRITE Request. All the WRITE Requests must be sorted according to their LBA to get best performance before being dispatched to the underlying storage (822). When all the WRITE Requests complete, flush the data to the non-volatile storage (824).

If there are other IO Groups waiting to be processed (826), repeat the above workflow. When all the IO Groups are being handled (826), the Intermediate Index and Root Index will be updated as well.

Conclusively, inserting a new Blob's metadata information to the Global Index requires one READ Request in average, and 1/n WRITE Request. If there are 64 records in a single Leaf Index Page, and the Insertion Buffer's threshold for every page in the Leaf Index is 64, then “n” is 64. In other words, every 64 new Blobs' metadata information requires one WRITE Request.

As a conclusion, querying one Blob's metadata information in the Global Index requires 1 to 3 READ Requests; inserting one Blob's metadata information requires 2 to 4 READ Requests and WRITE Request is almost zero.

FIG. 10B illustrates the updates for the Intermediate Index and the Root Index. The update for the Intermediate Index involves two types: update the existing record's maximum fingerprint or minimum fingerprint, or add a new record to the Intermediate Index (850). Adding the pending records to an existing page in the Leaf Index may require updating for the Intermediate Index record, and allocating a new page or page splitting requires adding new records to the Intermediate Index. Since the Intermediate Index is organized in continuous pages, adding new records to some a page may lead to the page becoming full (852). If some a page becomes full, it must be split into multiple pages as well (854). The Root Index keeps the mapping relationship from hash value to the Page No of the Intermediate Index, so when page splitting happens in the Intermediate Index, the Root Index must be appended new mapping relationships to represent the new records (856).

All the required pending updates on the Intermediate Index are remembered through module (FIG. 10A, 820). If all of the pending updates have been merged to the Intermediate Index (858), to flush the updated Intermediate Index records to the non-volatile storage (860); otherwise, repeat step 850 to 858. When the Intermediate Index updates have been flushed, the Root Index updates must be flushed to the non-volatile storage as well (862).

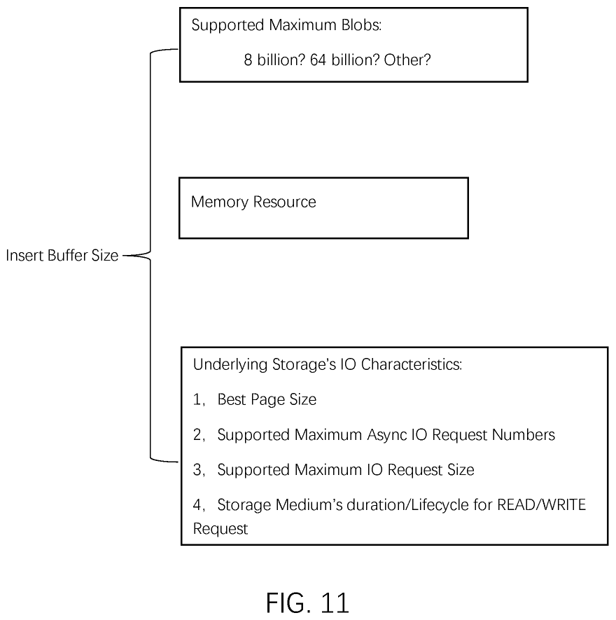

FIG. 11 is an illustration on how to determine the Insertion Buffer's size. The purpose of the Insertion Buffer is to reduce the write amplification. For example, if the Hash Function has 64 K buckets and assuming page size is 4 KB, then the Insertion Buffer's size can be set to 256 MB. In the initial stage, the Leaf Index is empty. And after the first merge, the size of Leaf Index is 256 MB. There are no write amplifications at all. For the second merge, almost 100% pages in the Leaf Index gets updated. In this merge process, 256 MB data size is inserted to the Leaf Index but 512 MB data updates happen. So, the write amplification factor is 2. After multiple merging actions, the write amplification factor gets bigger and bigger. The method to reduce the increased amplification factor is to increase the Insertion Buffer's size.

If there are enough primary storage resource so that the whole Insertion Buffer can be loaded to the memory, the Blob Group and IO Group building can be done in the low-latency memory. Otherwise, one “merge sort” for the Insertion Buffer must be done with limited low-latency memory resource before building the Blob Group and IO Group.

The Global Index's underlying storage's IO characteristics and underlying Operating System also plays an important role in determining the Insertion Buffer's size. The Leaf Index's page size should be aligned with the Operating System's page size to make full use of the advanced features such like memory management, file system caching, read ahead cache, etc. and gets the best performance. The underlying disk's endurance and lifecycle for READ/WRITE requests is another vital parameter. IO Merging takes a huge amount of IO requests for the underlying storage. The invention has taken in this consideration during the whole design to try the best to avoid hot spot in the underlying storage medium. Here the “hot spot” means some sector or area in the storage medium which encounters frequently READ or WRITE operations. For magnetic hard drive, 8 billion Blobs is a recommended upper limit to avoid hot spot in the magnetic medium and potentially causes medium failure. For SSD disk, with the benefit of “wear leveling” technique, the hot spot issue is nearly resolved and hence the supported Blob number can reach to a higher level beyond than the current requirement for Indexing Service. From the underlying storage's perspective, this invention works much better on SSD drive.

What's claimed is:

1. A method for Indexing for massive Blob/objects comprising:
a fingerprint generator which is responsible for generating the non-collision fingerprint among the Multi-Level Index, and every fingerprint can uniquely identify one Blob; and
a hash function which can almost equally distribute the massive Blobs' fingerprints to the buckets of the hash function; and
a Multi-Level Index which includes the Root Index, zero or one or more Intermediate Indexes and the Leaf Index, in which the Root Index maintains the summary information for the top-level Intermediate Index in the event that there is at least one Intermediate Index or the Root Index maintains the summary information for the Leaf Index in the event that there are no Intermediate Indexes, and the top-level Intermediate Index maintains the summary information for the next-level Intermediate Index if there are multiple Intermediate Indexes or the Intermediate Index maintains the summary information for the Leaf Index in the event that there is only one Intermediate Index, and the Leaf Index is composed by records in which every record comprises the Blob's fingerprint, hash value and related metadata information for the Blob; and
an Indexing Service which updates the Multi-Level Index by adding new record to the Leaf Index and further updates the Intermediate Indexes or even the Root Index accordingly if needed, and it accesses the Multi-Level Index to perform lookup operation based on the fingerprint computed for the Blob and the hash value computed for the fingerprint, and the lookup starts from the Root Index, and the Intermediate Index and finally reaches to the Leaf Index, and return the metadata information associated with the fingerprint and hash value if found in the Leaf Index, or to return a not-found result if not found in the Leaf Index.

2. A method for Indexing for massive Blob/objects as recited in claim 1 wherein the Leaf Index is organized in continuous pages, wherein every page contains a set of records which have the same hash value and the records are sorted according to the Blob's fingerprint value.
In the event that there are multiple pages in which the records have the same hash value, every page has a fingerprint range from the minimum fingerprint to the maximum fingerprint, and every range doesn't overlap with the others in these pages.

3. A method for Indexing for massive Blob/objects as recited in claim 1 wherein the Intermediate Index is organized in continuous pages, binary tree, red-black tree, or B-Tree.

4. A method for Indexing for massive Blob/objects as recited in claim 1 wherein the Root Index is organized in mapping from hash value calculated for a Blob to the page number in the lower-level Index.

5. A method for Indexing for massive Blob/objects as recited in claim 1 wherein the Indexing Service is further configured to use the Insertion Buffer to queue a set of pending records which will be inserted to the Leaf Index, and to merge these records to the Leaf Index later in batch-mode to reduce the write amplification for the Multi-Level Index.

6. A method for Indexing for massive Blob/objects as recited in claim 5 wherein the Insertion Buffer size is determined by various parameters: supported maximum Blobs and underlying Storage's IO Characteristics.

7. A method for Indexing for massive Blob/objects as recited in claim 5 wherein the merge comprises of:
reading related pages from the Leaf Index; and
inserting the pending records to the pages, for those records which don't have a related page in the Leaf Index, allocate enough pages from the low-latency memory to hold these records; and
sorting the records by their fingerprint in all these pages; and
writing these pages back to the Leaf Index; and
update the Intermediate Index or the Root Index if needed.

8. A method for Indexing for massive Blob /objects as recited in claim 7 wherein the reading or writing phase can be split into multiple steps, every step only dispatches a subset of all the IO Requests to the underlying storage. Moreover, in every step, the dispatched IO Requests may get sorted according to the underlying storage's IO Characteristics to get best performance.

9. A method for Indexing for massive Blob/objects as recited in claim 7 wherein the insertion phase may lead to one page to be split into two or more pages if the number of records inserted to some a page has reached to the maximum supported record number for a single page; and
A new page involves updating for the Intermediate Index and even the Root Index.

10. A method for Indexing for massive Blob/objects as recited in claim 1 wherein the Indexing Service is further configured to use the Deletion Buffer to queue a set of pending records which will be deleted from the Leaf Index, and to delete these records from the Leaf Index later in batch-mode to reduce the write amplification for the Multi-Level Index.

11. A method for Indexing for massive Blob/objects as recited in claim 10 wherein the Deletion Buffer size is determined by various parameters: supported maximum Blobs and underlying Storage's IO Characteristics.
